(19) United States
(12) Patent Application Publication
(10) Pub. No.: US 2021/0122015 A1
(43) Pub. Date: Apr. 29, 2021

(54) RATCHET WRENCH AND METHOD FOR ASSEMBLING THE SAME

(71) Applicant: JEN-YU WANG, Taichung City (TW)

(72) Inventor: JEN-YU WANG, Taichung City (TW)

(21) Appl. No.: 16/664,951

(22) Filed: Oct. 28, 2019

(51) Int. Cl. B25B 23/00; B25B 13/46

(52) U.S. Cl. CPC B25B 23/0007; B25B 13/463

(57) ABSTRACT

A ratchet wrench includes wrench body having a head which has a first side and a second side. A through hole is defined through the first and second sides. A first face and a second face are formed on the inner periphery of the through hole. The first face faces the first side. The second face faces the second side. A ratchet wheel is rotatably accommodated in the through hole and includes a first surface formed in a radial direction of the ratchet wheel, and the ratchet wheel further includes a second surface which extends in the axial direction of the ratchet wheel. The first surface contacts the second face. The second surface contacts the first face which is located substantially in an axial direction of the through hole. A sharp angle is formed between the first and second surfaces.

### BACKGROUND OF THE INVENTION

### 1. Fields of the Invention

The present invention relates to a ratchet wrench and a method for assembling the ratchet wrench, and more particularly, to a ratchet wrench with a ratchet wheel that is positioned in the head of the wrench without using any C-clip or cover.

### 2. Descriptions of Related Art

The conventional ratchet wrench includes a head with a through hole, and a ratchet wheel is rotatably accommodated in the through hole. A C-clip or a cover is used to position the ratchet wheel in the through hole and prevents the ratchet wheel from dropping from the through hole.

However, the assembling steps for positioning the ratchet wheel are complicated and consumes a lot of time. In addition, there are many small parts involved in the limited space when assembling the ratchet wheel in the through hole of the wrench head, and this requires a skilled person to finish the assembly.

The present invention is intended to provide a ratchet wrench and the ratchet wheel is installed in the through hole easily. The present invention also provide a method for assembling the ratchet wrench.

### SUMMARY OF THE INVENTION

The present invention relates to a ratchet wrench and comprises a wrench body having a head with a first side and a second side which is located opposite to the first side. A through hole is defined through the head of the wrench body and communicates with the first and second sides. A first face and a second face are formed on the inner periphery of the through hole. The first face faces the first side, and the second face faces the second side. A ratchet wheel is rotatably accommodated in the through hole and includes a first surface formed in the radial direction of the ratchet wheel. Besides, the ratchet wheel includes a second surface which extends in the axial direction of the ratchet wheel. The first surface contacts the second face, and the second surface contacts the first face which is located substantially in the axial direction of the through hole. A sharp angle is formed between the first and second surfaces.

The preset invention further provides a method for assembling the ratchet wrench, and the method comprises:

a first step: providing a wrench body which includes a first side and a second side which is located opposite to the first side, a through hole defined through the head of the ratchet wrench and communicating with the first and second sides, a first face and a second face formed on the inner periphery of the through hole, the first face facing the first side, the second face facing the second side;

a second step: providing a ratchet wheel which includes a flange, a first surface and a second surface, the flange extending from the first end of the ratchet wheel, the second surface formed on the outer periphery of the flange;

a third step: accommodating the ratchet wheel in the through hole;

a fourth step: contacting the first surface with the second face, and

a fifth step: enlarging a distal end of the flange to contacting the second surface with the first face.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the ratchet wrench of the present invention;

FIG. 2 is an exploded view of the ratchet wrench of the present invention;

FIG. 3 is another perspective view to show the ratchet wrench of the present invention;

FIG. 4 is an enlarged view of the ratchet wheel of the ratchet wrench of the present invention;

FIG. 5 is an enlarged view of a portion of the ratchet wheel of the ratchet wrench of the present invention;

FIG. 6 is an cross sectional view, taken along line III-III of FIG. 3;

FIG. 7 is an enlarged view of to show a portion of the ratchet wheel installed in the through hole of the ratchet wrench of the present invention;

FIG. 8 shows that a press member is to press the distal end of the flange of the ratchet wheel of the ratchet wrench of the present invention;

FIG. 9 shows that the press member presses the distal end of the flange of the ratchet wheel of the ratchet wrench of the present invention, and

FIG. 10 shows that the distal end of the flange of the ratchet wheel of the ratchet wrench of the present invention is pressed by the press member.

### DETAILED DESCRIPTION OF THE PREFERRED EMBODIMENT

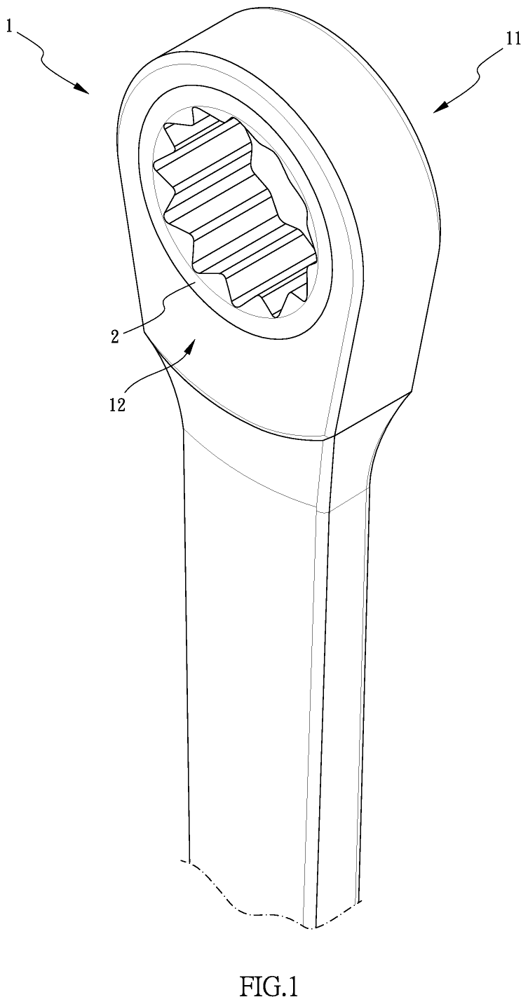

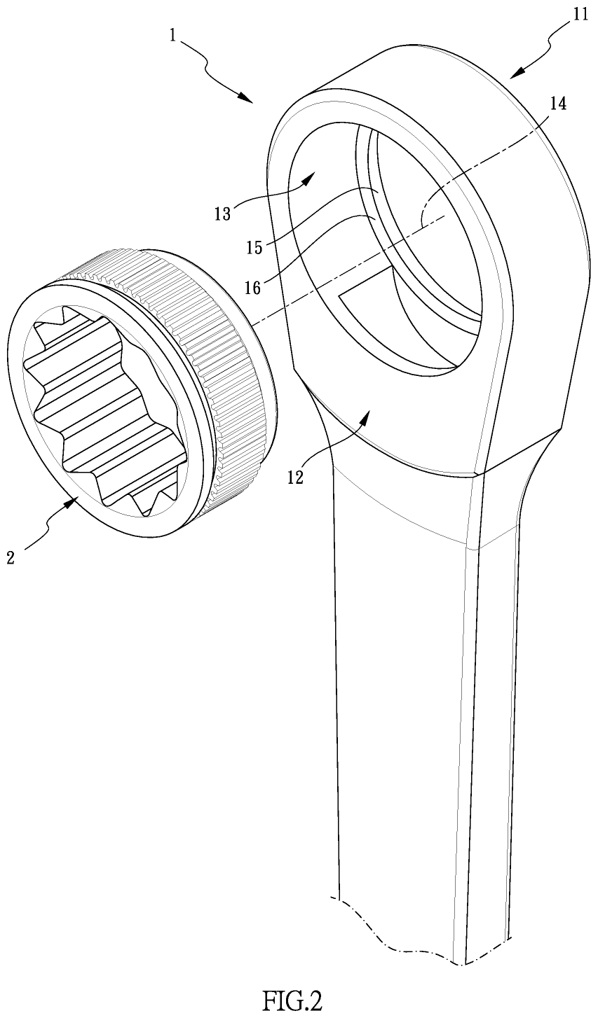

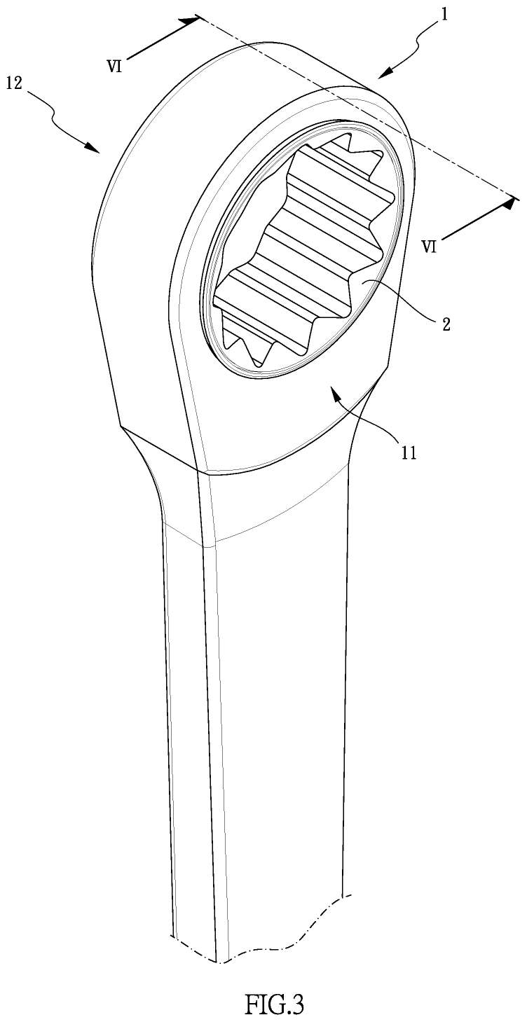

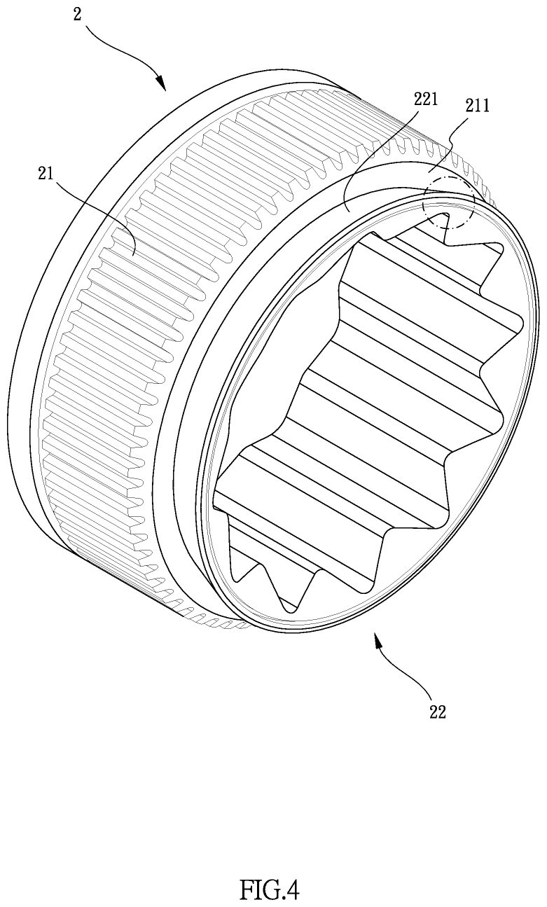

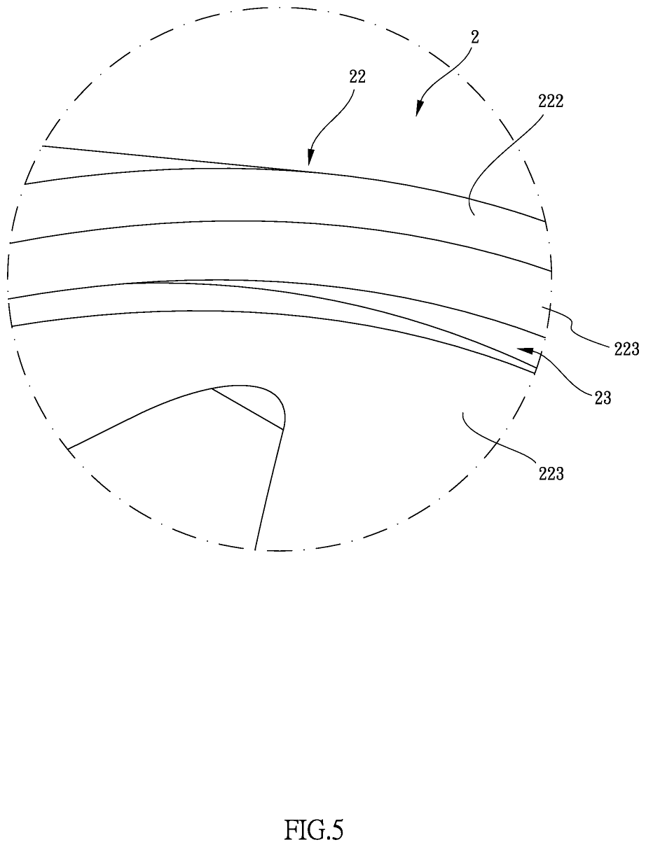

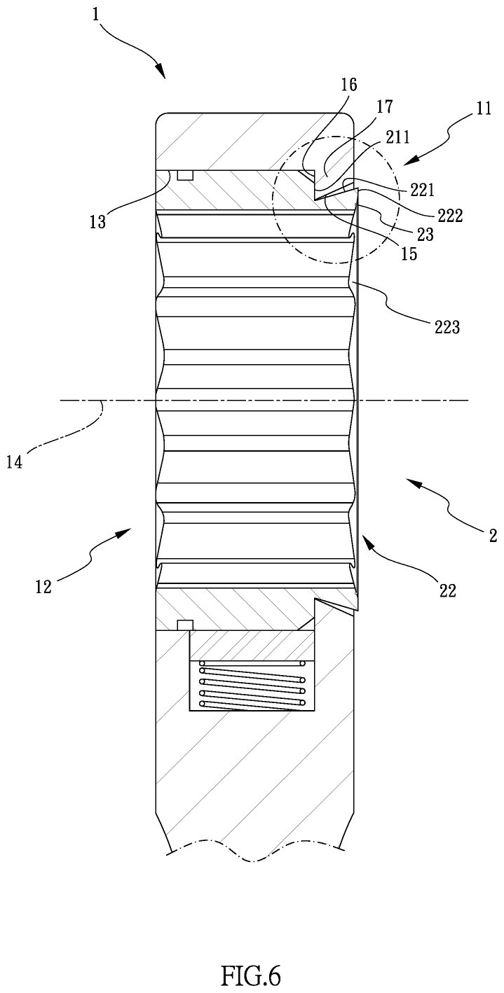

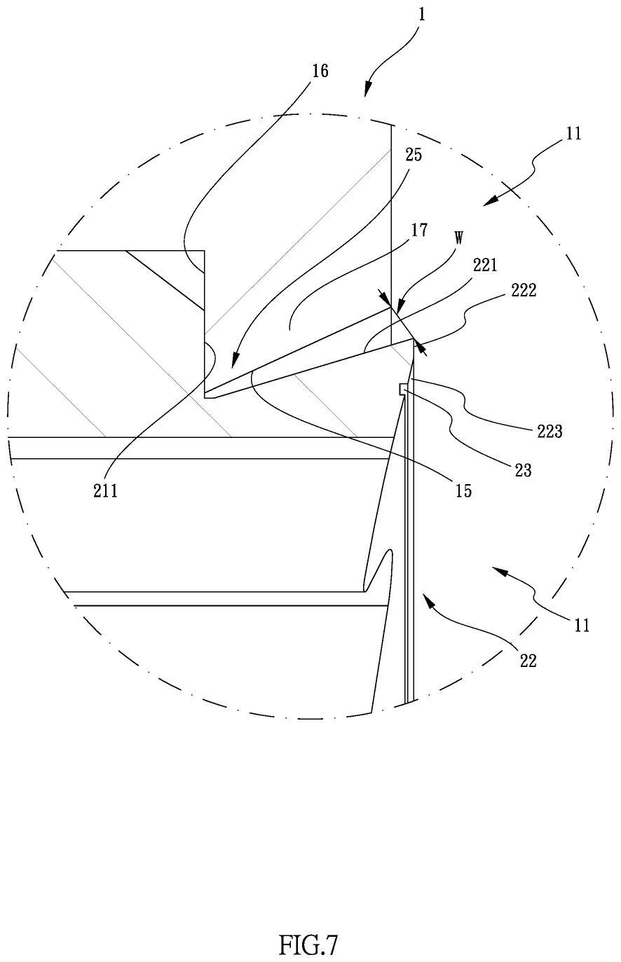

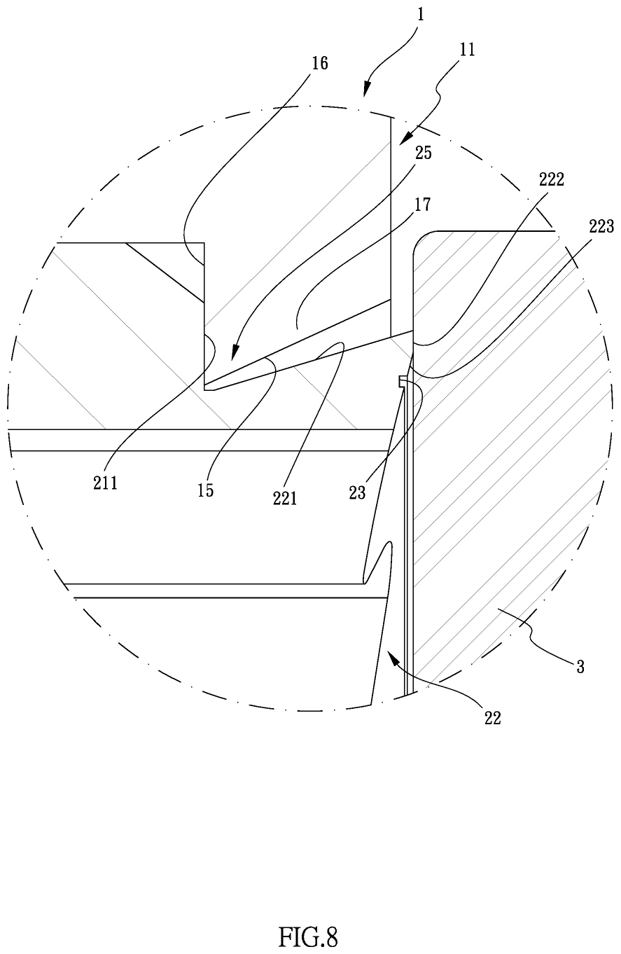

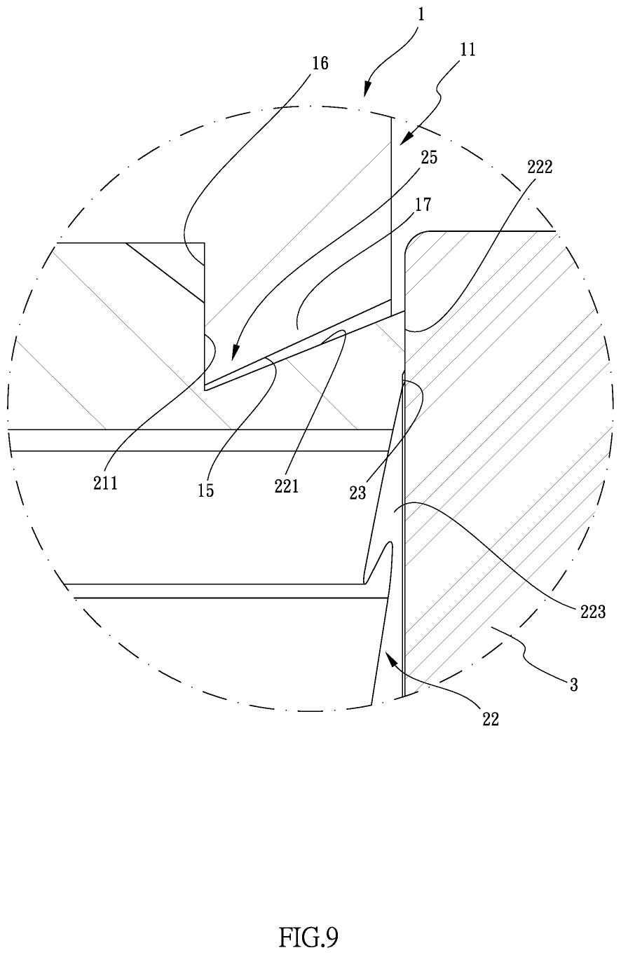

Referring to FIGS. 1 to 10, the ratchet wrench of the present invention comprises a wrench body 1 having a head and a handle, wherein the head has a first side 11 and a second side 12 which is located opposite to the first side 11. A through hole 13 is defined through the head of the wrench body 1 and communicates with the first and second sides 11, 12. A ridge 17 extends radially and inward from the inner periphery of the through hole 13. A first face 15 and a second face 16 are respectively formed on two different directions of the ridge 17. The first face 15 faces the first side 11, and the second face 16 faces the second side 12. The first face 15 is inclined from the first side 11 of the head of the wrench body 1 toward the second side 12 of the head of the wrench body 1. The first face 15 extends toward an axis 14 of the through hole 13. The second face 16 is formed in the radial direction of the through hole 13. The ridge 17 is located at the first side 11 of the head of the wrench body 1.

A ratchet wheel 2 is rotatably accommodated in the through hole 13, and the ratchet wheel 2 is inserted into the through hole 13 from the second side 12 of the head of the wrench body 1. The ratchet wheel 2 includes a body 21 and a flange 22 which is an annular flange and extends axially from the first end of the body 21 of the ratchet wheel 2. The body 21 of the ratchet wheel 2 has teeth formed on the outer periphery thereof. A first surface 211 is formed on the first end of the body 21 of the ratchet wheel 2 and extends in the radial direction of the ratchet wheel 2. A second surface 221 is formed on the outer periphery of the flange 22 and extends substantially in the axial direction of the ratchet wheel 2. The first surface 211 inclinedly extends from the first end of the body 21 of the ratchet wheel 2 so as to form a recessed area 25 between the first and second surfaces 211, 221. A sharp angle is formed between the first and second surfaces 211, 221.

When the ratchet wheel 2 is inserted into the through hole 13 from the second side 12 of the head of the wrench body 1, the ridge 17 is accommodated in the recessed area 25 and located between the first and second surfaces 211, 221. The first surface 211 of the ratchet wheel 2 contacts the second face 16. The second surface 221 of the ratchet wheel 2 contacts the first face 15. The distal end of the flange 22 is in flush with the first side 11 of the head of the wrench body 1. The second end of the body 21 of the ratchet wheel 2 is in flush with the second side 12 of the head of the wrench body 1.

The ratchet wheel 2 is positioned in the through hole 13 by the contact between the first surface 211 of the ratchet wheel 2 and the second face 16, and by the contact between the second surface 221 of the ratchet wheel 2 and the first face 15. Accordingly, the ratchet wheel 2 does shake due to elimination of multiple manufacturing tolerances of multiple parts, and can be installed precisely. Not any C-clip or bolt is needed, and this also simplified the steps of assembly of the ratchet wrench.

The inclined first face 15 provides various contact areas both in radial direction and axial direction so as to well position the ratchet wheel 2. Besides, the second face 16 extends radially from the inner periphery of the through hole 13 so as to evenly share machining stress during manufacturing stage.

The present invention also provides a method for assembling the ratchet wrench as described, and the method comprises:

a first step: providing a wrench body 1 which includes a first side 11 and a second side 12 which is located opposite to the first side 11, a through hole 13 defined through the head of the ratchet wrench 1 and communicating with the first and second sides 11, 12, a first face 15 and a second face 16 formed on an inner periphery of the through hole 13, the first face 15 facing the first side 11, the second face 16 facing the second side 12;

a second step: providing a ratchet wheel 2 which includes a flange 22, a first surface 211 and a second surface 221, the flange 22 extending from a first end of the ratchet wheel 2, the second surface 221 formed on an outer periphery of the flange 22;

a third step: accommodating the ratchet wheel 2 in the through hole 13;

a fourth step: contacting the first surface 211 with the second face 16, and

a fifth step: enlarging a distal end of the flange 22 to contacting the second surface 221 with the first face 15.

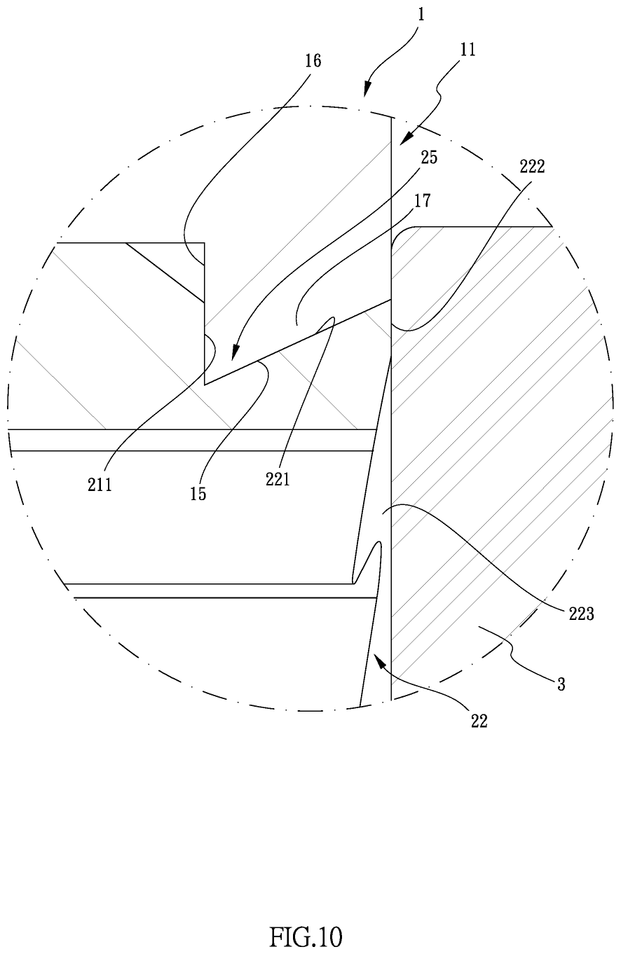

The distal end of the flange 22 includes a groove 23 defined therein which is an annular groove. The distal end of the flange 22 is flattened and enlarged by a press member 3 which presses the distal end of the flange 22 along the axial direction of the through hole 13 so as to be in flush with the first side 11 of the wrench body 1. The groove 23 is filled by material of the flange 22 as shown in FIG. 10 when the distal end of the flange 22 is flattened and enlarged by the press member 3.

It is noted that a width “w” of 0.1 mm to 0.5 mm is formed between the outer edge of the distal end of the flange 22 to the outer edge of the first face 15 at the first side 11 of the head of the wrench body 1 before the distal end of the flange 22 is pressed. The maximum distance between the second surface 221 to the first face 15 in the radial direction of the through hole 13 is between 0.1 mm to 0.2 mm. By this maximum distance between the second surface 221 to the first face 15 in the radial direction of the through hole 13, the force that the press member 3 applies to the flange 22 does not overly affect other portion so that the flange 22, the second surface 221 are deformed to contact the first face 15.

Specifically, the distal end of the flange 22 includes a flat area 222 and an inclined area 223, wherein the radial length of the flat area 22 is larger than that of the inclined area 223. The groove 23 is defined in the inclined area 223. When the press member 3 presses the flat area 222, the groove 23 is filled, and the flat area 222 is in flush with the first side 11 of the wrench body 1. Because the second surface 221 is inclined from the first side 11 toward the second side 12, in other words, an extension line extending from the second surface 221 will intersect the axis 14 of the through hole 13, so that when the press member 3 presses the distal end of the flange 22 along the axial direction of the through hole 13, the distal end of the flange 22 is deformed evenly to keep the axis of the flange 22 to be identical to the axis 14 of the through hole 13.

The ratchet wheel 2 is inserted into the through hole 13 from the second side 12 of the wrench body 1 to contact the first surface 211 with the second face 16. The maximum distance that the flat area 222 of the flange 22 protrudes beyond the first side 11 of the wrench body 1 is between 0.1 mm to 0.4 mm when the second end of the ratchet wheel 2 is in flush with the second side 12 of the wrench body 1 and the press member 3 has not yet pressed the flange 22. The specific maximum distance of 0.1 to 0.4 mm of the flat area 222 of the flange 22 protruding beyond the first side 11 of the wrench body 1 is helpful to make the flat 222 to be in flush with the first side of the head of the wrench body 1.

While we have shown and described the embodiment in accordance with the present invention, it should be clear to those skilled in the art that further embodiments may be made without departing from the scope of the present invention.

What is claimed is:

1. A ratchet wrench comprising:
a wrench body having a head with a first side and a second side which is located opposite to the first side, a through hole defined through the head of the wrench body and communicating with the first and second sides, a first face and a second face formed on an inner periphery of the through hole, the first face facing the first side, the second face facing the second side, and
a ratchet wheel rotatably accommodated in the through hole and including a first surface formed in a radial direction of the ratchet wheel, the ratchet wheel including a second surface which extends in an axial direction of the ratchet wheel, the first surface contacting the second face, the second surface contacting the first face which is located substantially in an axial direction of the through hole, a sharp angle formed between the first and second surfaces.

2. The ratchet wrench as claimed in claim 1, wherein the first face is inclined from the first side of the head of the wrench body toward the second side of the head of the wrench body, the first face extends toward an axis of the through hole.

3. The ratchet wrench as claimed in claim 1, wherein the second face is formed in a radial direction of the through hole.

4. The ratchet wrench as claimed in claim 1, wherein a ridge extends radially and inward from the inner periphery of the through hole, the first and second faces are formed on the ridge, the ridge is located between the first and second surfaces.

5. The ratchet wrench as claimed in claim 4, wherein the second face extends in a radial direction of the through hole, the first face is inclined from the first side of the head of the wrench body toward the second side of the head of the wrench body, the first face extends toward an axis of the through hole, the ridge is located at the first side of the head of the wrench body, the ratchet wheel includes a body and a flange which is an annular flange and extends axially from a first end of the body of the ratchet wheel, the first surface is formed on the first end of the body of the ratchet wheel, the second surface is formed on an outer periphery of the flange, the first surface inclinedly extends from the first end of the body of the ratchet wheel, a recessed area is formed between the first and second surfaces, the ridge is accommodated in the recessed area, a distal end of the flange is in flush with the first side of the head of the wrench body, a second end of the body of the ratchet wheel is in flush with the second side of the head of the wrench body.

6. A method for assembling a ratchet wrench, comprising:
a first step: providing a wrench body which includes a first side and a second side which is located opposite to the first side, a through hole defined through the head of the ratchet wrench and communicating with the first and second sides, a first face and a second face formed on an inner periphery of the through hole, the first face facing the first side, the second face facing the second side;
a second step: providing a ratchet wheel which includes a flange, a first surface and a second surface, the flange extending from a first end of the ratchet wheel, the second surface formed on an outer periphery of the flange;
a third step: accommodating the ratchet wheel in the through hole;
a fourth step: contacting the first surface with the second face, and
a fifth step: enlarging a distal end of the flange to contacting the second surface with the first face.

7. The method as claimed in claim 6, wherein the distal end of the flange is flattened and enlarged by a press member which presses the distal end of the flange along an axial direction of the through hole so as to be in flush with the first side of the wrench body.

8. The method as claimed in claim 7, wherein the distal end of the flange includes a groove defined therein, the groove is filled by material of the flange when the distal end of the flange is flattened and enlarged by the press member.

9. The method as claimed in claim 6, wherein the second surface is inclined from the first side of the head of the wrench body toward the second side of the head of the wrench body, the second surface extends toward an axis of the through hole.

10. The method as claimed in claim 8, wherein the second surface is inclined from the first side of the head of the wrench body toward the second side of the head of the wrench body, the second surface extends toward an axis of the through hole, a width of 0.1 mm to 0.5 mm is formed between the an outer edge of the distal end of the flange to an outer edge of the first face at the first side of the head of the wrench body before the distal end of the flange is pressed, a maximum distance between the second surface to the first face in a radial direction of the through hole is between 0.1 mm to 0.2 mm, the groove is an annular groove, the distal end of the flange includes a flat area and an inclined area, a radial length of the flat area is larger than that of the inclined area, the groove is defined in the inclined area, when the press member presses the flat area, the groove is filled, the flat area is in flush with the first side of the wrench body, the ratchet wheel is inserted into the through hole from the second side of the wrench body to contact the first surface with the second face, a maximum distance that the flat area of the flange protrudes beyond the first side of the wrench body is between 0.1 mm to 0.4 mm when a second end of the ratchet wheel is in flush with the second side of the wrench body and the press member does not press the flange.
